(19) United States
(12) Patent Application Publication
(10) Pub. No.: US 2007/0290425 A1
(43) Pub. Date: Dec. 20, 2007

(54) Elastomer Bearing

(76) Inventors: Karl Heuer, Nortrup (DE); Helmut Kammel, Damme (DE); Klaus Kramer, Neuenkirchen (DE); Tim-Malte Franke, Damme (DE)

Correspondence Address: MCGLEW & TUTTLE, PC, P.O. BOX 9227, SCARBOROUGH STATION, SCARBOROUGH, NY, 10510-9227, US

(21) Appl. No.: 11/575,250

(22) PCT Filed: Sep. 14, 2005
(86) PCT No.: PCT/DE05/01611

§ 371 Date: Jul. 5, 2007

(30) Foreign Application Priority Data
Sep. 15, 2004 (DE) 10 2004 045 064.1

(51) Int. Cl. F16F 1/38; F16C 27/06

(52) U.S. Cl. 267/293; 267/141.2

(57) ABSTRACT

An elastomer bearing (1) has an inner part (2), an outer sleeve (4) surrounding the inner part (2) coaxially to a bearing longitudinal axis (3) defining the center of the bearing and an elastomer body (5) arranged between the inner part (2) and the outer sleeve (4). The elastomer body (5) has at least one bulge (6), adjacent to which at least one tapered section (7, 8) each is located on both sides when viewed in the direction of the longitudinal axis (3) of the bearing. The outer sleeve (4) has axial end sections with a deformation (9, 10) each directed towards the inside of the bearing. Before the elastomer bearing (1) is mounted in a motor vehicle component (11), the elastomer body (5) has recesses (12, 13) on the axial front sides of the elastomer bearing (1), and the recesses (11, 12) are filled by the elastomer body (5) up to the area of the deformations (9, 10) after the elastomer bearing (1) has been inserted into the motor vehicle component (11).

### CROSS REFERENCE TO RELATED APPLICATIONS

This application is a United States National Phase application of International Application PCT/DE2005/001611 and claims the benefit of priority under 35 U.S.C. §119 of German Patent Application DE 10 2004 045 064.1 filed Sep. 15, 2004, the entire contents of which are incorporated herein by reference.

### FIELD OF THE INVENTION

The present invention pertains to an elastomer bearing with an inner part, an outer sleeve, which surrounds the inner part coaxially to a bearing longitudinal axis defining the center of the bearing, and with an elastomer body, which is arranged between the inner part and the outer sleeve.

### BACKGROUND OF THE INVENTION

Elastomer bearings are used in motor vehicles to absorb vibrations of various frequency ranges. To achieve the desired absorption, an elastomer body is accordingly arranged between an inner part and an outer sleeve in prior-art elastomer bearings. Rubber, which can be prepared from natural rubber and whose properties can be varied by adding additives, is used mostly as the elastomer body, so that absorption characteristics corresponding to the particular requirements can be obtained with the prior-art elastomer bearings. However, the steadily increasing requirements on elastomer bearings for use in motor vehicles make it necessary to increase the number of variants.

An elastomer bearing, in which the elastomer body arranged between the inner part and the outer sleeve has a bulge and at least one tapered section each is present adjacent to the bulge when viewed in the direction of the longitudinal axis of the bearing, is known from U.S. Pat. No. 5,820,115. The bulge of the elastomer bearing described in the document meshes with a groove-like depression of the inner part. Axial excursion of the elastomer bearing between the inner part and the outer sleeve is said to be prevented by this measure.

A solution similar to that described before also appears from U.S. Pat. No. 1,827,233. A class-forming design of an elastomer bearing is shown especially in FIG. 6 and is described in more detail in the corresponding description in the latter document.

Experiments have shown that axial mobility of the elastomer body between the inner part and the outer sleeve cannot be effectively prevented from occurring by a groove-like depression on the inner part, with which the bulge of the elastomer body meshes. Additional axial stops are rather necessary in the embodiment variants on the front side in order to prevent the elastomer body from yielding in the axial longitudinal direction. It is just as impossible to achieve high radial stiffness, i.e., low mobility of the outer sleeve relative to the inner part, during loading in the direction at right angles to the longitudinal axis of the bearing, with the prior-art elastomer bearings as an effective axial supporting of the elastomer body without contact areas to be provided additionally on the elastomer body. Such complex requirements cannot be met with the solutions known from the state of the art. It is known that reinforcing elements can be introduced as intermediate layers into the elastomer body in order to thus increase the strength of the elastomer in the radial direction. Not only do the material and manufacturing costs increase as a result, but the necessary external dimensions become larger as well, which is disadvantageous in view of the limited space available for installation in modern motor vehicles.

### SUMMARY OF THE INVENTION

The basic object of the present invention is to provide an elastomer bearing that has high radial stiffness, axial stability of the elastomer body, low torsion-proofness and longer service life compared to prior-art embodiments. Furthermore, the largest possible number of variants shall be obtained along with a simple design.

An elastomer bearing according to the present invention is accordingly characterized in that the outer sleeve has axial end sections with a deformation each, which is directed towards the inside of the bearing, and that before the elastomer bearing is mounted in a motor vehicle component, the elastomer body has recesses on the axial front sides of the elastomer bearing, which said recesses are filled by the elastomer body up to the area of the deformations after the elastomer bearing has been inserted into the motor vehicle component.

Several requirements imposed on such an elastomer bearing for use in a motor vehicle can be met with an elastomer bearing according to the present invention. The very high radial stiffness, i.e., the relatively low mobility of the outer sleeve relative to the inner part in the direction extending at right angles to the longitudinal axis of the housing, is achieved by the partially enlarged elastomer volume, which is present approximately in the center of the bearing as a consequence of the bulge. As a consequence of this, these axial end areas of the elastomer bearing have tapered sections. However, the advantageous overall absorption characteristics of the elastomer bearing according to the present invention are also made possible by the deformations present on the front side, which prevent the axial excursion of the elastomer body at least partially. The required low torsion-proofness of the elastomer bearing according to the present invention is affected by the properties of the elastomer body, which predetermines the parameters that are decisive for this due to its inner molecular structure if there is a connection in substance between the elastomer body, the inner part and the outer sleeve. However, it is likewise possible that the elastomer body is connected only to the inner part or to the outer sleeve in an adherent manner in order to obtain a torsionally weak design.

On the whole, a very simple design, which can be manufactured at low cost and requires only a few standardized individual parts in the form of a modular system, was created with the elastomer bearing according to the present invention.

Corresponding to an embodiment of the present invention, it is proposed, furthermore, that the fiber length of the elastomer be greater in the area of the bulge than in the adjacent tapered sections. The radial stiffness of the elastomer bearing as a whole can be improved by this difference in the fiber lengths. Moreover, the axial mobility of the elastomer bearing can also be influenced hereby, however.

To meet the need for an elastomer bearing that can be used with the smallest possible number of individual parts for different motor vehicles and applications, a kind of modular system is proposed. This can be embodied by standardized components, which are modified in details only corresponding to the requirements imposed on the elastomer bearing. Thus, a highly advantageous embodiment of the present invention is based on the fact that the inner part has a groove-like depression, which receives the bulge of the elastomer body.

To increase the possibilities of combination, it is proposed, furthermore, that inserts made of a material different from the material of the inner sleeve of the inner part be inserted into the depression. However, the insert may also be introduced into the depression of the inner part by means of a connection in substance, for example, by means of an injection process or in another manner. It is thus possible to use a uniform, standardized inner part with a depression, into which modularly different inserts can be introduced, depending on the requirements imposed on the elastomer bearing and the elastomer to be used, so that the width of the bulge of the elastomer body can be varied hereby.

To influence the characteristics of the elastomer bearing, collars present on the axial front sides are advantageous, for example, to limit the freedom of motion of the elastomer body in the axial direction. These collars can be produced by partially expanding the inner part, but it is just as possible to arrange the collars on the inner part later.

An especially simple variant of the present invention may be to provide the inner part with a continuously regular cylindrical geometry. This embodiment makes possible a high level of variability in terms of the shaping of the inner part.

Thus, it is possible, for example, to attach the aforementioned collars on the uniformly standardized inner part or to provide the outer sleeve with a bulged expansion, with which the bulge of the elastomer body meshes. Furthermore, such an embodiment of the inner part makes it possible to arrange at least one jacket with a central depression, into which the bulge of the elastomer body is inserted, on the outer surface. Providing a jacket each on the axial end sections of the inner part is also within the scope of the present invention, in which case the jackets should be located at spaced locations from one another when viewed in the direction of the longitudinal axis of the bearing, so that a groove-like depression, which is used to receive the bulge of the elastomer body, is formed between the jackets.

Insofar as a groove-like depression is mentioned in connection with the present invention, this may be provided as a circumferential depression or as a depression located in some sections on the inner part or on the outer sleeve.

It is common to the aforementioned suggestions that the central area of the elastomer body, which is present approximately in the center of the bearing, has a bulge, which meshes with a complementarily shaped depression of the inner part or of the outer part, so that a greater height of the elastomer body can be achieved at least in some sections in this central area when viewed in the cross section, and the requirements imposed on the elastomer bearing in terms of radial stiffness can be met.

The inserts of the collars and/or the at least one jacket may consist of a plastic in an elastomer bearing according to the present invention or manufactured from another material, for example, a material that can be processed by injection molding. Inserts or collars or jackets made of metals such as aluminum or other materials are conceivable as well.

In order not to influence the properties of the elastomer body in an undesired manner, it is advantageous to provide the outer sleeve of the elastomer bearing with a jacket surface that is closed in itself over its circumference.

To influence the properties of the elastomer bearing according to the present invention, it is advantageous, moreover, to calibrate same by radial deformation of the inner part and/or the outer sleeve before it is installed in the motor vehicle component. Either the external dimensions of the outer sleeve are reduced and/or the external dimensions of the inner part are enlarged, i.e., widened. The elastomer body is prestressed by the calibration. The final requirements imposed on the elastomer bearing in terms of the properties of the elastomer body are attained by the final installation of the elastomer bearing in the motor vehicle component.

It shall be mentioned in connection with the elastomer bearing according to the present invention that it is possible in the sense of the solution being proposed that the elastomer body has a connection in substance to the inner part and/or the outer part, so that at least there is an adherent connection between the elastomer body and at least one of the parts of the elastomer body. The adherent connection may be produced already during the vulcanization process of the elastomer or later. The torsion-proofness of the elastomer body can be reduced by such a measure to such an extent that the elastomer body possesses sliding properties to a limited extent.

However, an adherent connection is not obligatory, so that one embodiment of the present invention also provides for a design in which the elastomer body is only inserted between the inner part and the outer sleeve without there having to be an adherent connection.

Moreover, it is useful in the course of the simplification of the design of an elastomer bearing according to the present invention to design the elastomer bearing as a whole as a radially symmetrical bearing.

The solution according to the present invention leads, on the whole, to an elastomer bearing that guarantees high radial stiffness with low torsion-proofness. It has a very simple design and can be composed from standardized components in the sense of a modular system according to the requirements imposed on the elastomer bearing for different vehicle models. An undercut is created by the bulge of the elastomer body in the central area of the elastomer bearing. The parameters of the elastomer bearing can be set very meticulously by calibrating the elastomer body. The axial load-bearing capacity is limited essentially by the deformation of the outer limit or by the expansion or the formation of collars on the outer jacket of the inner part. A longer elastomer fiber is obtained due to the elastomer body designed according to the present invention in the central area, in which the bulge is located, than in the tapered sections located adjacent to this bulge, so that there is a reduced fiber length in the tapered sections compared to the bulge.

Various preferred embodiments of an elastomer bearing according to the present invention will be explained in more detail below on the basis of the drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a first embodiment variant of an elastomer bearing according to the present invention as an individual part;

FIG. 2 is a sectional view taken through the elastomer bearing shown in FIG. 1 in the direction of the longitudinal axis of the bearing;

FIG. 3 is a sectional view showing an elastomer bearing according to FIG. 1, inserted into a motor vehicle component;

FIG. 4 is is a sectional view along the longitudinal axis of the bearing another embodiment of an elastomer bearing according to the present invention as an individual part;

FIG. 5 is a sectional view along the longitudinal axis of the bearing the elastomer bearing according to FIG. 4, inserted into a motor vehicle component;

FIG. 6 is a sectional view along the longitudinal axis of the bearing showing another advantageous variant of an elastomer bearing according to the present invention as an individual part;

FIG. 7 is an enlarged detail sectional view according to view VII in FIG. 6;

FIG. 8 is a sectional view the elastomer bearing shown in FIG. 6, which is mounted in a motor vehicle component;

FIG. 9 is a perspective view of another embodiment of an elastomer bearing according to the present invention as an individual part;

FIG. 10 is a sectional view along the longitudinal axis of the bearing showing the elastomer bearing shown in FIG. 9;

FIG. 11 is a sectional view along the longitudinal axis of the bearing showing the elastomer bearing shown in FIGS. 9 and 10 in a motor vehicle component;

FIG. 12 is a perspective view of an embodiment variant of an elastomer bearing according to the present invention as an individual part;

FIG. 13 is a sectional view along the longitudinal axis of the bearing in a sectional view along the longitudinal axis of the bearing; and

FIG. 14 is a sectional view along the longitudinal axis of the bearing showing the elastomer bearing shown in FIGS. 12 and 13, mounted in a motor vehicle component.

### DESCRIPTION OF THE PREFERRED EMBODIMENTS

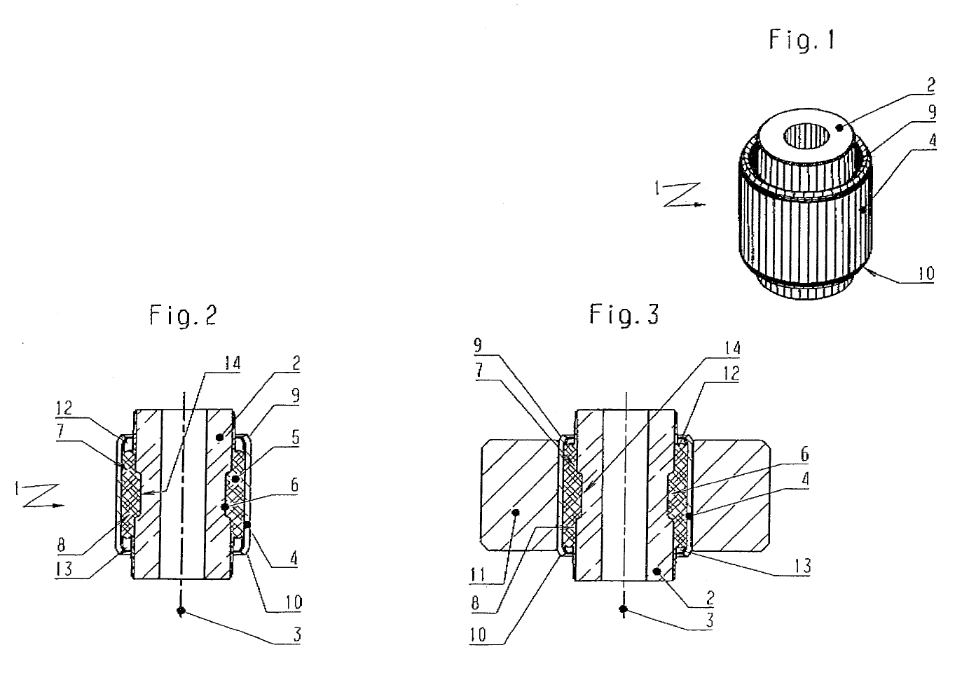

Referring to the drawings in particular, the exemplary embodiment of an elastomer bearing according to the present invention, designated as a whole by 1, which is shown in FIG. 1, comprises essentially an inner part 2 and an outer sleeve 4 surrounding this coaxially to the longitudinal axis of the bearing, between which an elastomer body 5, which cannot be recognized in FIG. 1, is arranged. The outer sleeve has as a peculiarity deformations 9 and 10, respectively, which are directed towards the inside of the bearing, on the axial end sections of the outer sleeve and which limit the axial path of deformation of the elastomer body 5 located between the inner part 2 and the outer sleeve 4, the axial path of deformation being traveled during the calibration.

FIG. 2 shows an elastomer bearing according to the present invention corresponding to the embodiment variant in FIG. 1 in a sectional view along the longitudinal axis 3 of the bearing. This figure clearly shows the inner structure of this first embodiment variant. The elastomer bearing 1 has an inner part 2, an outer sleeve 4 and an elastomer body 5 arranged between the inner part 2 and the outer sleeve 4. The elastomer body 5 has, in its central area, a bulge 6, which meshes with a complementary, groove-like depression 14 or of the inner part 2. On its axial front sides, a first portion of the elastomer body 5 has recesses 12 and 13, respectively. Tapered sections 7 and 8 with a reduced cross section compared to the bulge 6 are present on the elastomer body 5 adjacent to the bulge 6 of the elastomer body 5 when viewed in the longitudinal direction of the longitudinal axis 3 of the bearing. The fiber length of the elastomer is shorter in these sections 7, 8 than in the area of the bulge 6.

FIG. 3 shows a use of the elastomer bearing 1 according to the present invention. This elastomer bearing 1, shown as a sectional view, largely corresponds to the view in FIG. 1. Only the recesses 12 and 13 are reduced by the calibration, i.e., by the reduction of the diameter of the outer sleeve 4, to the nominal size of the mounting lug of the motor vehicle component 11, so that the elastomer body 5 has undergone an axial excursion and fills the recesses 12, 13 up to the area of the deformations 9 and 10, respectively, of the outer sleeve 4.

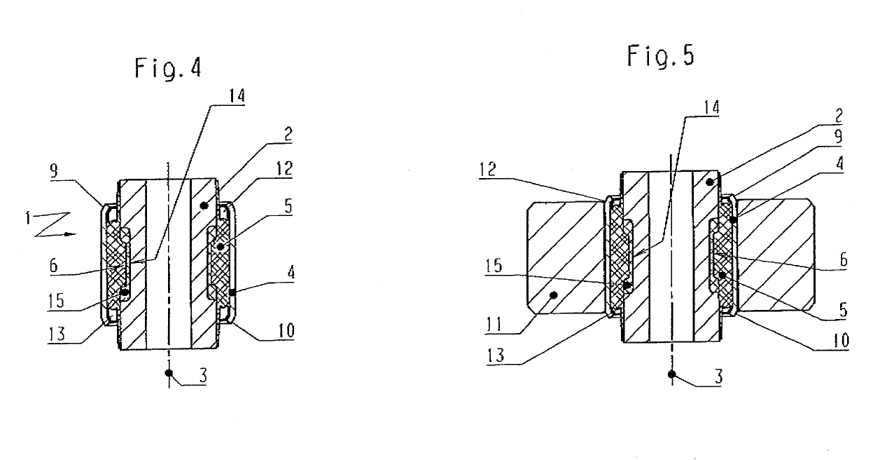

FIGS. 4 and 5 show sectional views of another embodiment of an elastomer bearing according to the present invention, FIG. 4 showing the elastomer bearing 1 as a separate component and FIG. 5 showing an elastomer bearing 1 inserted into a motor vehicle component 1 1. The peculiarity of the embodiment variants in FIGS. 4 and 5 is that a very simple inner part 2 which can be used in a multivalent manner is used here in the sense of a modular system. The inner part 2 has a standardized, groove-like depression 14, which can be used for bearings having different characteristics. The individual types of elastomers are distinguished by the use of differentiated inserts 15. The insert 15 is designed as a plastic insert introduced by injection molding in the embodiment according to FIG. 4, so that a reduced depression is formed compared to the original groove-like depression 14 of the inner part 2, and, as was already described above, the bulge 6 of the elastomer body 5 meshes with this depression.

After the elastomer bearing 1 has been installed in the motor vehicle component 11, the recesses 12 and 13 of the elastomer body 5 are largely filled, as was already described in connection with the first embodiment, so that the elastomer body 5 extends up into the area of the deformations 9 and 10 in the axial direction.

The geometry of the outer sleeve 4 corresponds in this embodiment variant to the view in FIG. 1, so that it can be recognized herefrom as well that standardized components can be used for elastomer bearings with different requirement profiles.

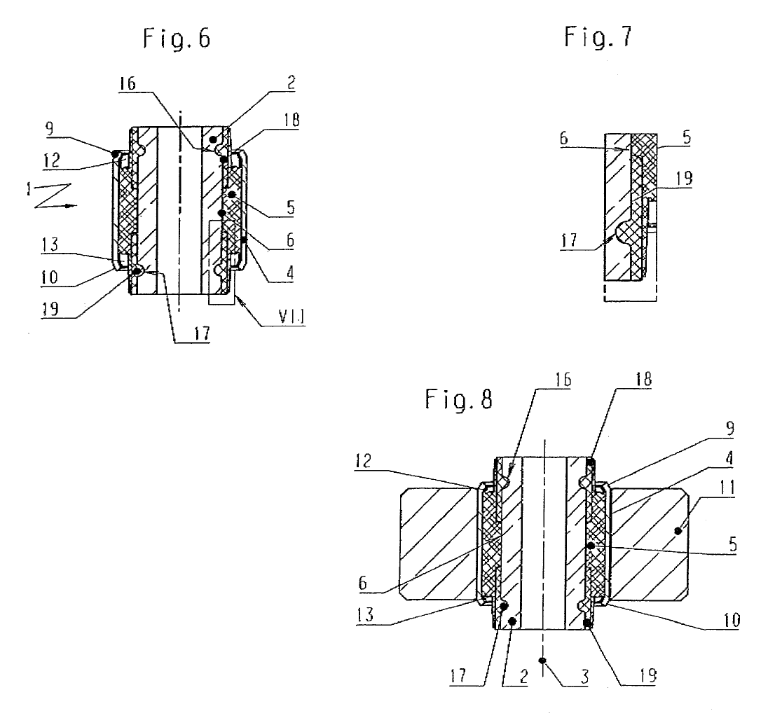

FIG. 6 shows another, very advantageous embodiment of an elastomer bearing 1 according to the present invention. An inner part 2 with a regular cylindrical cross section is used here. A jacket 18 and 19, respectively, is attached in the axial end areas of this inner part 2 having a regular cylindrical cross section. This jacket 18, 19 is designed mainly as a plastic molding and meshes with beads 16, 17 present complementarily in the inner part by dog-like expansions, so that a positive-locking connection is guaranteed hereby. It is also possible to prepare the jackets 18, 19 directly by injection. When viewed in the direction of the longitudinal axis 3 of the bearing, the jackets 18 and 19 are located at spaced locations from one another in the central area of the inner part 2, so that a groove-like depression is formed for receiving the bulge 6 of the elastomer body, which comes directly into contact with the outer surface of the inner part 2 in the embodiment according to FIG. 6. Simple variation of the parameters of the elastomer bearing is possible in this embodiment as well, without having to change the dimensions of the outer sleeve 4 of the inner part 2. As a result, both the radial stiffness and the torsion-proofness and the axial loadability of an elastomer bearing 1 according to the present invention can be varied as desired.

FIG. 7 shows the enlarged detail VII from FIG. 6. The bead 17, with which the dog of the jacket 19 meshes, is recognizable here once again.

FIG. 8 shows an elastomer bearing 1 according to FIG. 6, which is inserted into a motor vehicle component 11. A prestress is introduced into the elastomer body 5 by the calibration of the elastomer bearing 1, so that the recesses 12 and 13 are filled by the elastomer body 5 up into the area of the deformations 9 and 10.

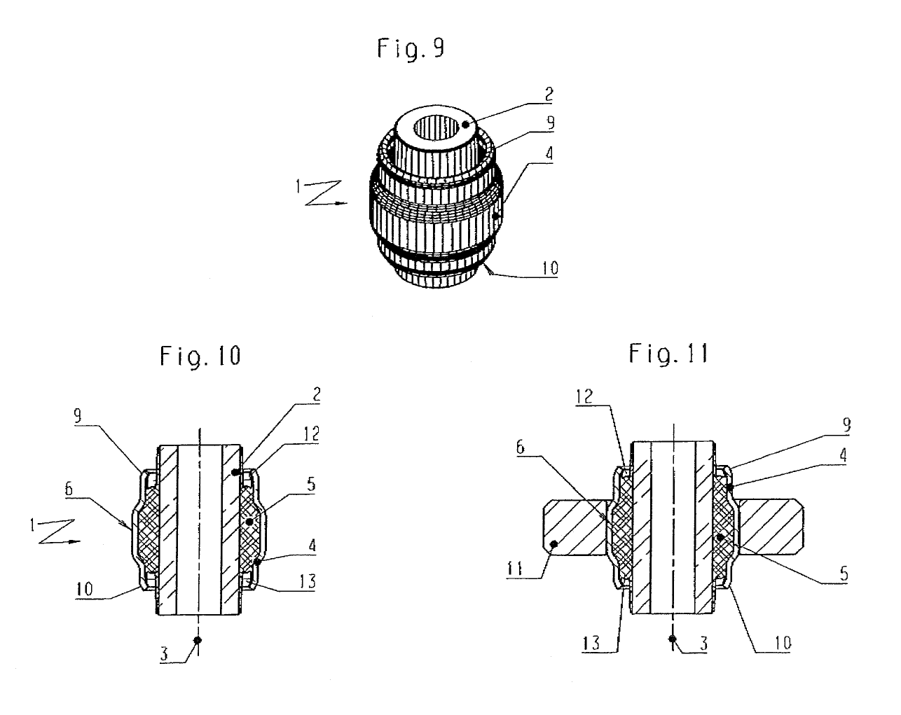

FIGS. 9 through 11 show a special elastomer bearing 1 according to the present invention. The inner part 2 being used here is designed as a component with a continuously regular cylindrical cross section. The inner part 2 is not provided with a depression 14 in this embodiment, but the outer sleeve 4 has a bulge, with which the bulge 6 of the elastomer body 5 meshes. FIG. 9 shows the perspective view of an elastomer bearing 1 of such a design as an individual part, while FIG. 10 shows a sectional view of the elastomer body 1 along the longitudinal axis 3 of the bearing and FIG. 11 shows the elastomer bearing 1 mounted in a motor vehicle component 11.

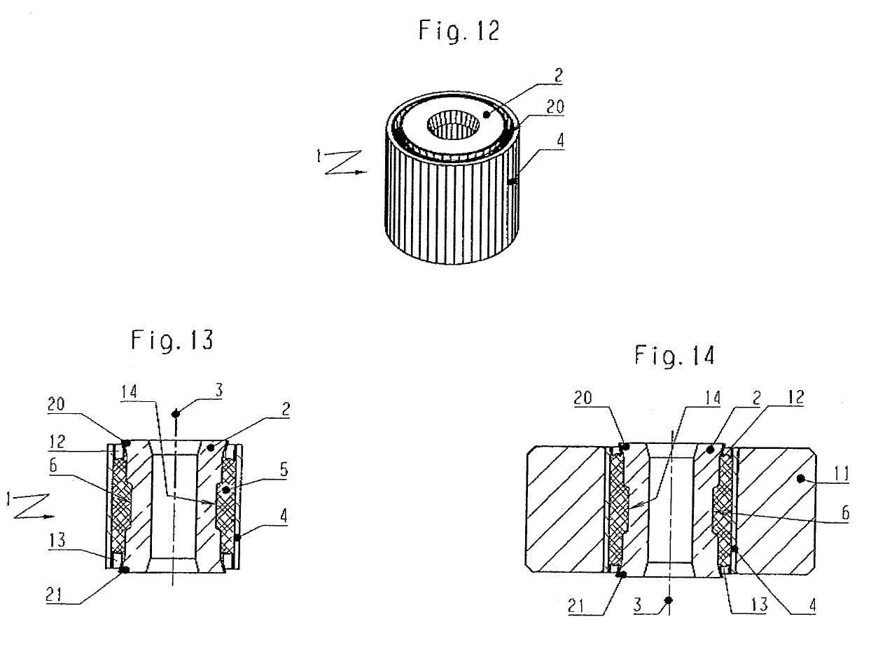

FIGS. 12 through 14 show, moreover, an embodiment variant, which has an inner part 2 with a centrally arranged, groove-like depression 14, with which the complementary bulge 6 of the elastomer body 5 meshes. There are no deformations on the axial end areas on the outer sleeve 4 designed as a regular cylinder. The outer sleeve 4 rather has continuously a regular cylindrical geometry. To keep the axial excursion of the elastomer body 5 in the direction of the longitudinal axis 3 of the bearing within bounds, the inner part 2 is widened on its front sides in the solution being shown here, so that a collar 20 and 21, respectively, is formed in these sections. The perspective view in FIG. 12 clearly shows the structure of this variant of a bearing, while the sectional view in FIG. 13 shows the inner structure. Moreover, the installation position in a motor vehicle component 11 can be recognized in FIG. 14. Just as in the variants of an elastomer bearing 1 according to the present invention described before, the recesses 12 and 13 are extensively filled by the elastomer of the elastomer body 5 according to FIG. 14. The collars 20, 21, which are present on the axial front sides of the inner part 2, rather than the deformations of the outer sleeve 4, act here as an axial limitation of the expansion of the elastomer body 5 in the axial direction.

While specific embodiments of the invention have been shown and described in detail to illustrate the application of the principles of the invention, it will be understood that the invention may be embodied otherwise without departing from such principles.

1. An elastomer bearing for insertion into a motor vehicle component, the elastomer bearing comprising:
an inner part;
an outer sleeve surrounding a region of said inner part and positioned coaxially to a bearing longitudinal axis defining the center of the bearing; and
an elastomer body arranged between said inner part and said outer sleeve, said elastomer body having at least one bulge adjacent to which at least one tapered section is located on both sides when viewed in the direction of said bearing longitudinal axis, said outer sleeve having a deformed portion at each axial end thereof directed towards the inside of the bearing and said elastomer body defining a recesses on each of the axial ends of said elastomer bearing in a state before said elastomer bearing is mounted in said motor vehicle component, and filling a region of said recesses up to the area of said deformations after said elastomer bearing has been inserted into said motor vehicle component.

2. An elastomer bearing in accordance with claim 1, wherein said elastomer body has a fiber length in said first elastomer portion that is greater in the area of said bulge than a fiber length in said second elastomer portions in adjacent tapered sections.

3. An elastomer bearing in accordance with claim 1, wherein said inner part has a groove-like depression, which receives said bulge of said elastomer body.

4. An elastomer bearing in accordance with claim 3, wherein an insert made of a material different from the material of said inner part is received in said depression.

5. An elastomer bearing in accordance with claim 1, wherein said inner part includes collars made integrally with axial end sections of said inner part or arranged on said outer surface of said axial end sections of said inner part.

6. An elastomer bearing in accordance with claim 1, wherein said inner part has continuously a regular cylindrical geometry.

7. An elastomer bearing in accordance with claim 6, wherein said outer sleeve has a bulged expansion, which receives said bulge of said elastomer body.

8. An elastomer bearing in accordance with claim 6, wherein said inner sleeve has on its outer surface at least one jacket with a central depression for receiving said bulge of said elastomer body.

9. An elastomer bearing in accordance with claim 6, wherein said inner sleeve has a jacket on each of its said axial end sections, said jackets being located at spaced locations from one another when viewed in the direction of said bearing longitudinal axis, so that a depression is formed between said jackets for receiving said bulge of said elastomer body.

10. An elastomer bearing in accordance with claim 4, wherein said insert consists of a plastic fastened to said inner part or injected directly on said inner part.

11. An elastomer bearing in accordance with claim 1, wherein said outer sleeve has a jacket surface that is closed in itself over its circumference.

12. An elastomer bearing in accordance with claim 1, wherein said elastomer bearing is subjected to calibration before installation in said motor vehicle component by a radial deformation of said inner part and/or of said outer sleeve, as a result of which said elastomer body has a prestress.

13. An elastomer bearing in accordance with claim 1, wherein said elastomer body has a connection in substance to said inner part and/or said outer sleeve.

14. An elastomer bearing in accordance with claim 1, wherein said elastomer body is inserted between said inner part and/or said outer sleeve while avoiding an adherent connection.

15. An elastomer bearing in accordance with claim 1, wherein said elastomer bearing as a whole has a radially symmetrical design.

16. An elastomer bearing in accordance with claim 4, wherein said insert consists of a plastic and is either fastened to said inner part or injected directly on said inner part.

17. An elastomer bearing in accordance with claim 5, wherein said collars consist of a plastic fastened to said inner part or injected directly on said inner part.

18. An elastomer bearing in accordance with claim 8, wherein said jacket consists of a plastic fastened to said inner part or injected directly on said inner part.

19. An elastomer bearing in accordance with claim 9, wherein said jacket consists of a plastic fastened to said inner part or injected directly on said inner part.

20. An elastomer bearing for insertion into a motor vehicle component, the elastomer bearing comprising:
an inner part;
an outer sleeve surrounding a region of said inner part and positioned coaxially to a bearing longitudinal axis defining the center of the bearing, said outer sleeve having a first end deformed portion at an axial end thereof directed towards the inside of the bearing and having a second end deformed portion at an axial end thereof directed towards the inside of the bearing; and
an elastomer body arranged between said inner part and said outer sleeve, said elastomer body having a bulge with a first end tapered section located on one axial side of said bulge and with a second end tapered section located on another axial side of said bulge, said elastomer body defining a first side axial recesses and a second axial side recess cooperating with said elastomer body, said inner part and said outer sleeve to define elastomer body expansion means filling a region of said recesses by said elastomer body up to the area of said deformations after said elastomer bearing has been inserted into the motor vehicle component.
